(19) United States
(12) Patent Application Publication
(10) Pub. No.: US 2007/0180990 A1
(43) Pub. Date: Aug. 9, 2007

(54) Dynamic halogenation of sorbents for the removal of mercury from flue gases

(76) Inventors: William Downs, Alliance, OH (US); George Albert Farthing JR., Alliance, OH (US)

Correspondence Address: Eric Marich;Patent Department, The Babcok & Wilcox Company, 20 South Van Buren Avenue, Barberton, OH, 44203-0351, US

(21) Appl. No.: 10/591,856

(22) PCT Filed: Mar. 21, 2005
(86) PCT No.: PCT/US05/09441

§ 371 Date: Sep. 5, 2006

Related U.S. Application Data
(60) Provisional application No. 60/555,281, filed on Mar. 22, 2004.

(51) Int. Cl. B01D 53/02

(52) U.S. Cl. 95/134

(57) ABSTRACT

A halogen-containing gas is injected into a flowing transport air/sorbent stream at a point close to the point where the sorbent and transport air first mix to maximize the residence time available for the halogen-containing compound to be adsorbed onto the sorbent surface prior to the sorbent being injected into a flue gas containing mercury. This process maximizes the benefit and utilization of the halogen-containing reagent by placing it exactly where it is needed to facilitate elemental mercury removal—on the surface of the sorbent. The sorbent particles with their loading of adsorbed halogen-containing reagent enter the flue gas with a high reactivity for the removal of elemental mercury.

### FIELD AND BACKGROUND OF THE INVENTION

Emissions Standards, as articulated in The Clean Air Act Amendments of 1990 as established by the U.S. Environmental Protection Agency (EPA), required assessment of hazardous air pollutants from utility power plants. In December 2000 the EPA announced their intention to regulate mercury emissions from coal-fired utility boilers. Coal-fired utility boilers are a known major source of anthropogenic mercury emissions in the United States. Elemental mercury and many of its compounds are volatile and will therefore leave the boiler as trace constituents in boiler flue gases. Some of these mercury constituents are insoluble in water, which renders them difficult to capture in conventional wet and dry scrubbers. Thus new methods and processes are needed to capture these trace constituents from boiler flue gases.

Mercury appears in coal combustion flue gases in both solid and gas phases (particulate-bound mercury and vapor-phase mercury, respectively). The so-called particulate-phase mercury is really vapor-phase mercury adsorbed onto the surface of ash or carbon particles. Due to the high volatility of mercury and many of its compounds, most of the mercury found in flue gases is vapor-phase mercury. Vapor-phase mercury can appear as elemental mercury (elemental, metallic mercury vapor) or as oxidized mercury (vapor-phase species of various compounds of mercury). Speciation, which refers to the form of mercury present, is a key parameter in the development and design of mercury control strategies. All efforts to devise new control strategies for mercury emissions from power plants must focus on this characteristic of mercury.

Particulate collectors in use at electric utility plants, most commonly electrostatic precipitators (ESP) or fabric filters (FF), sometimes called baghouses, provide high-efficiency removal of particulate-bound mercury. Fabric filters tend to exhibit better particulate-bound mercury removal than ESPs by providing a filter cake upon which to trap the particulate mercury as the flue gas passes through said filter cake. If the filter cake also contains constituents that will react with mercury such as unreacted carbon or even activated carbon, then the filter cake can act as a site to facilitate gas-solid reactions between the gaseous mercury and the solid carbon particles. If a power plant is equipped with a Flue Gas Desulfurization System (FGD) then either wet scrubbers or spray dryer absorbers (SDA) can remove significant amounts of oxidized mercury. Oxidized mercury, typically appearing in the form of mercuric chloride, is soluble in water, making it amenable to removal in sulfur dioxide scrubbers. Elemental mercury, insoluble in water, is less likely to be scrubbed in conventional scrubbers. Removal of elemental mercury, therefore, remains an important issue in the search for cost-effective mercury control techniques.

Numerous studies have been, and continue to be, conducted to develop cost-effective approaches to the control of elemental mercury. Many of the studies have focused on the injection of a carbonaceous sorbent (e.g., powdered activated carbon, or PAC) into the flue gas upstream of the particulate collector to adsorb vapor-phase mercury. The sorbent, and its burden of adsorbed mercury, are subsequently removed from the flue gases in a downstream particulate collector. Adsorption is a technique that has often been successfully applied for the separation and removal of trace quantities of undesirable components. PAC injection is used, commercially, to remove mercury from municipal waste combustor exhaust gases. PAC injection removes both oxidized and elemental mercury species, although removal efficiencies are higher for the oxidized form. Although this approach appeared attractive in early work, the economics of high injection rates can be prohibitive when applied to coal-fired utility plants. More refined studies are now in progress to define more precisely what can and cannot be achieved with PAC. Still other studies seek to enhance PAC technology. One technique subjects the PAC to an impregnation process wherein elements such as iodine or sulfur are incorporated into the carbonaceous sorbent. Such processes can yield sorbents that more strongly bond with adsorbed mercury species, but also result in significantly higher sorbent cost.

The speciation of vapor-phase mercury depends on coal type. Eastern U.S. bituminous coals tend to produce a higher percentage of oxidized mercury than do western subbituminous and lignite coals. Western coals have low chloride content compared to typical eastern bituminous coals. It has been recognized for several years that a loose empirical relationship holds between the chloride content of coal and the extent to which mercury appears in the oxidized form. FIG. 1 (Source: Senior, C. L. Behavior of Mercury in Air Pollution Control Devices on Coal-Fired Utility Boilers, 2001) illustrates the relationship between coal chlorine content and vapor-phase mercury speciation. An important reason for the significant scatter in the data of FIG. 1 is that mercury oxidation depends in part on the specific characteristics of the boiler as well as the fuel. The mercury oxidation reactions proceed by both homogeneous and heterogeneous reaction mechanisms. Factors such as boiler convection pass and combustion air preheater temperature profiles, flue gas composition, fly ash characteristics and composition, and the presence of unburned carbon have all been shown to affect the conversion of elemental mercury to oxidized mercury species.

Although elemental mercury can be adsorbed onto the surface of activated carbon, the capacity is very limited and reversible. That is, the mercury is bonded to the carbon is a simple adsorption scheme and will eventually evolve off the surface of the carbon to be re-emitted to the gas phase. If the mercury is to be permanently captured by the carbon, it must be converted (oxidized) on the surface. It has been observed that the reactivity of conventional PAC with elemental mercury vapor is dependent upon the presence of certain acid gas species (e.g., hydrogen chloride and sulfur trioxide) in the flue gas stream. The presence of hydrogen chloride (HCl), in particular, has been shown to significantly improve the adsorption of elemental mercury from coal combustion flue gases. The hydrogen chloride is apparently adsorbed onto the carbon surface, facilitating the subsequent oxidation of elemental mercury on the surface of the carbon. This phenomenon is of great practical importance for the application of PAC injection for mercury control for plants firing subbituminous and lignite coals. These coals tend to have very low chlorine content, and therefore produce combustion gases containing only small amounts of hydrogen chloride, and therefore would benefit significantly by the addition of hydrogen chloride in judicious ways.

The dearth of halogen-containing gases can be further exacerbated if the PAC injection process is operating downstream of a sulfur dioxide scrubber, such as a wet or SDA (“dry”) flue gas desulfurization system. The scrubber removes acid gases such as hydrogen chloride in addition to the removal of sulfur dioxide. As an example, consider the application of PAC injection to a unit equipped with SDA and a fabric filter that fires a low-chlorine coal. The concentration of hydrogen chloride in the flue gases resulting from the combustion of these coals is low. This concentration is further reduced by absorption in the SDA system. This renders the PAC largely ineffective for elemental mercury capture in the SDA and fabric filter. PAC must therefore be injected sufficiently far upstream of the SDA to allow for the capture of mercury prior to the removal of the acid gases in the SDA. This significantly limits the effective residence time available for mercury removal, and necessitates the use of high carbon injection rates.

Felsvang et al. (U.S. Pat. No. 5,435,980) teaches that the mercury removal of a coal-fired system employing an SDA system can be enhanced by increasing the chlorine-containing species (e.g., hydrogen chloride) in the flue gases. Felsvang et al. further teaches that this can be accomplished through the addition of a chlorine-containing agent to the combustion zone of the boiler, or through the injection of hydrochloric acid (HCl) vapor into the flue gases upstream of the SDA. These techniques are claimed to improve the mercury removal performance of PAC when used in conjunction with an SDA system.

### SUMMARY OF THE INVENTION

One aspect of the present invention is drawn to an inexpensive, yet effective method for increasing the concentration of hydrogen chloride, or other halogen-containing compounds, on the surface of the carbonaceous sorbent as the sorbent is conveyed to the injection location.

Another aspect of the present invention is drawn to the use of bromine-containing compounds (which the present inventors have determined through experimental testing are significantly more effective than chlorine-containing compounds) to enhance the capture of elemental mercury by carbonaceous sorbents.

Yet another aspect of the present invention is drawn to a method of mercury removal that is applicable to virtually all coal-fired utility power plants, including those equipped with wet or dry FGD systems, as well as those plants equipped only with particulate collectors.

The various features of novelty which characterize the invention are pointed out with particularity in the claims annexed to and forming a part of this disclosure. For a better understanding of the present invention, its operating advantages and the specific benefits attained by its uses, reference is made to the accompanying drawings and descriptive matter in which preferred embodiments of the invention are illustrated.

### BRIEF DESCRIPTION OF THE DRAWINGS

FIG. 1 is a graph illustrating the relationship between coal mercury content and mercury speciation for U.S. coals;

FIG. 2 is a schematic illustration of a first embodiment of the present invention; i.e., the Dynamic Halogenation™ process for treating sorbents for the removal of mercury from flue gases;

FIG. 3 is a graph illustrating mercury removal achieved through the use of the Dynamic Halogenation process for treating sorbents according to the present invention across a system comprised of spray dryer absorber (SDA) and fabric filter (FF);

FIG. 4 is a schematic illustration of a coal-fired electric utility plant configuration comprising a boiler and a downstream particulate collector;

FIG. 5 is a schematic illustration of a coal-fired electric utility plant configuration comprising a boiler and a downstream spray dryer absorber (SDA) and particulate collector; and

FIG. 6 is schematic illustration of a coal-fired electric utility plant configuration comprising a boiler and a downstream particulate collector and a wet flue gas desulfurization (FGD) system.

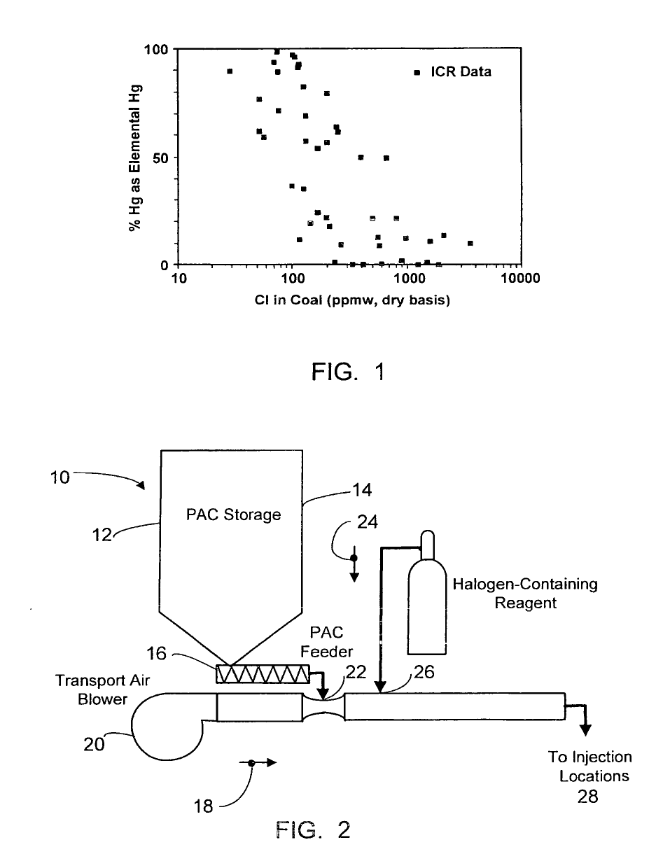

### DETAILED DESCRIPTION OF THE PREFERRED EMBODIMENTS

Referring to the drawings generally, wherein like numerals designate the same or functionally similar elements throughout the several drawings, and to FIG. 2 in particular, there is illustrated a preferred embodiment of the present invention, the Dynamic Halogenation process for treating sorbents for the removal of mercury from flue gases. As shown in FIG. 2, a system and method according to the present invention comprises a conventional powdered activated carbon (PAC) injection system 10 including a sorbent storage tank 12 containing a supply of sorbent 14, a means for metering 16 the sorbent 14 into a sorbent transport air stream 18, a sorbent transport air blower 20 for supplying the air 18 used to convey the sorbent 14 to the injection locations in the flue gas flue(s), and a pick-up point 22 where the sorbent 14 is dispersed into the transport air stream 18. It should be recognized that this is only one embodiment of a pneumatic transport conveying system, and many other configurations could be used or developed by one of ordinary skill in the art without departing from the scope of the present invention. The key aspect of the present invention is that a halogen-containing reagent or compound 24, which may be in gaseous form, is injected into the flowing transport air/sorbent stream at a point 26 close to the point 22 where the sorbent 14 and transport air 18 first mix together. The adsorption of the halogen-containing reagent 24 onto the sorbent particles 14 occurs during the transport of this gas-solid mixture to the point of injection 28 in a dynamic process. The rate of adsorption of halogen during this transport is relatively high because of the locally high concentration of halogen in the transport line. Once the sorbent enters the flue or SDA the rate of desorption of halogen from the surface of the carbon is too slow compared to the residence time for reaction with mercury to lose significant quantities of halogen back to the gas phase. This is why the inventors refer to the present invention and process as Dynamic Halogenation. This design maximizes the residence time available for the halogen-containing compound 24 to be adsorbed onto the sorbent 14 surface prior to the sorbent 14 being injected into the flue gas flue(s), the injection locations being generally designated 28. This process maximizes the benefit and utilization of the halogen-containing reagent 24 by placing it exactly where it is needed to facilitate elemental mercury removal—on the surface of the sorbent 14. The sorbent 14 particles with their loading of adsorbed halogen-containing reagent 24 enter the flue gas flue(s) injection locations 28 with high reactivity for the removal of elemental mercury.

The present invention is advantageous to the approaches of the prior art. The removal of elemental mercury from coal combustion gases generated by electric utility plants through the application of a conventional PAC injection process is very expensive. The present invention promises to significantly reduce the cost of mercury removal at coal-fired electric plants. First, the process provides the benefits, in terms of reactivity with elemental mercury, of replacing an expensive, pretreated PAC sorbent (e.g., iodine-impregnated PAC) with a conventional, low-cost sorbent.

The present invention is an improvement over Felsvang et al. (U.S. Pat. No. 5,435,980) because the present invention makes much more efficient use of the halogen-containing reagent 24 by placing it onto the carbon sorbent 14 surface just prior to injection into the flue gases. In the transport line, the sorbent does not have to compete with the alkaline fly ash or SDA lime slurry for the available halogen gas. It has been found by the inventors, and by several other investigators, that the addition of hydrogen chloride gas to the flue gases separately of the PAC injection system, as taught by Felsvang et al., does not significantly improve the elemental mercury removal performance of the PAC injection process. This is due to the fact that much of the injected hydrogen chloride reacts with other flue gas constituents (e.g., calcium compounds contained in the coal fly ash particles), thereby preventing the halogen from adsorbing onto the sorbent and thereby enhancing the performance of the injected PAC. By making efficient use of the halogen-containing reagent 24, the present invention permits much lower addition rates for the halogen-containing reagent 24 relative to other methods for halogen addition. The present invention also has a significant advantage over other means of adding halogen-containing compounds 24 to the flue gases in that the boiler and other power plant components are not subjected to the corrosive nature of the halogen compounds. This is especially true when compared to the addition of halogens to the boiler combustion chamber. High-temperature corrosion of boiler components by chlorides is a well-known and serious concern.

The present invention was tested in a 5 million Btu/hr Small Boiler Simulator (SBS) Facility. The SBS was fired at approximately 4.3 million Btu/hr with a western U.S. subbituminous coal. During these tests flue gases exiting the SBS boiler first passed through a spray dryer absorber (SDA) for removal of sulfur dioxide, and then through a fabric filter (FF) for removal of fly ash and spent sorbent from the SDA system.

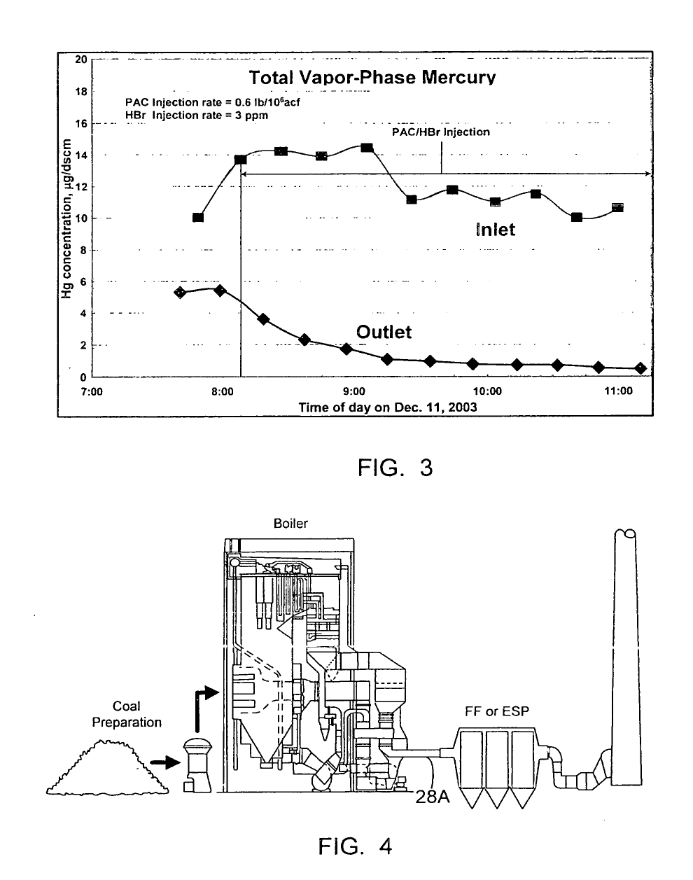

A stream of Dynamically Halogenated PAC, prepared by the method of the present invention, was injected into the flue gas stream downstream of the SDA, and upstream of the fabric filter. Hydrogen bromide (HBr), hydrogen chloride and chlorine gases were each examined. All were effective, but HBr was most effective. The halogen-containing reagent 24, and a commercially-produced PAC were used as the carbonaceous sorbent 14. FIG. 3 illustrates the removal of mercury across the SDA/FF system during operation of the Dynamic Halogenation process with HBr. It can be seen that upon injection of the Dynamically Halogenated PAC, the vapor-phase mercury exiting the system dropped from its initial value of approximately 6 μg/dscm to well below 1 μg/dscm. Other significant observations included: 1) PAC injection, alone, at a similar injection rate provided no discernable mercury removal; 2) the use of hydrogen bromide was more effective than the use of hydrogen chloride; and 3) the rates of addition of both the hydrogen bromide and PAC were many times lower than the rates for other halogen addition processes and conventional PAC injection processes, respectively. Conventional PAC injection can require 10 pounds of PAC or more per million cubic feet of flue gas to achieve 90% control of mercury compared to 0.6 pound per million cubic feet of flue gas utilizing the subject invention. The amount of halogen gas required to affect this improvement is on the order of a thousand times less than what would be required by direct injection of halogen gas directly into the flue or SDA. These results indicate that the present invention offers a very cost-effective method of removing elemental mercury from coal combustion flue gases. Based upon the testing conducted, it is believed that desired levels of mercury removal will be achieved by providing (using terms commonly used in the power generation industry) halogen containing reagent 24 at a rate equivalent to up to about 4 moles of halogen per million moles of flue gas, and by providing at least about 0.1 pounds of sorbent 14 per million cubic feet of flue gas.

In the preferred embodiment illustrated in FIG. 2, the halogen-containing reagent 24 is either hydrogen bromide or bromine (Br₂), and the carbonaceous sorbent 14 and halogen-containing reagent 24 are brought together in the sorbent pneumatic transport line with sufficient residence time for the halogen-containing reagent 24 to be adsorbed onto the carbonaceous sorbent 14 particle before the sorbent 14 is injected into the coal combustion flue gas stream. Based upon the testing conducted, it is estimated that a residence time of about 0.5 to about 1.0 second was achieved.

In yet another embodiment the coal-fired boiler fuel may include bituminous, subbituminous, and lignite coals and blends, thereof. The present invention is not limited to applications where coal is being combusted. It may also be applied to any type of combustion process where mercury emissions are to be controlled, such as in connection with combustion processes involving the combustion of municipal solid waste in incineration plants.

In yet another embodiment, the bromine-containing reagent 24 could comprise hydrogen bromide gas (HBr) or bromine (Br₂).

In yet another embodiment, the halogen-containing gases 24 may include any one or more of the following: hydrogen chloride, chlorine (Cl₂), as well as compounds of fluorine and iodine, and halide derivatives thereof.

In yet another embodiment, the carbonaceous sorbents 14 may include, but are not limited to, powdered activated carbon (PAC), carbons and chars produced from coal and other organic materials, and unburned carbon produced by the combustion process itself.

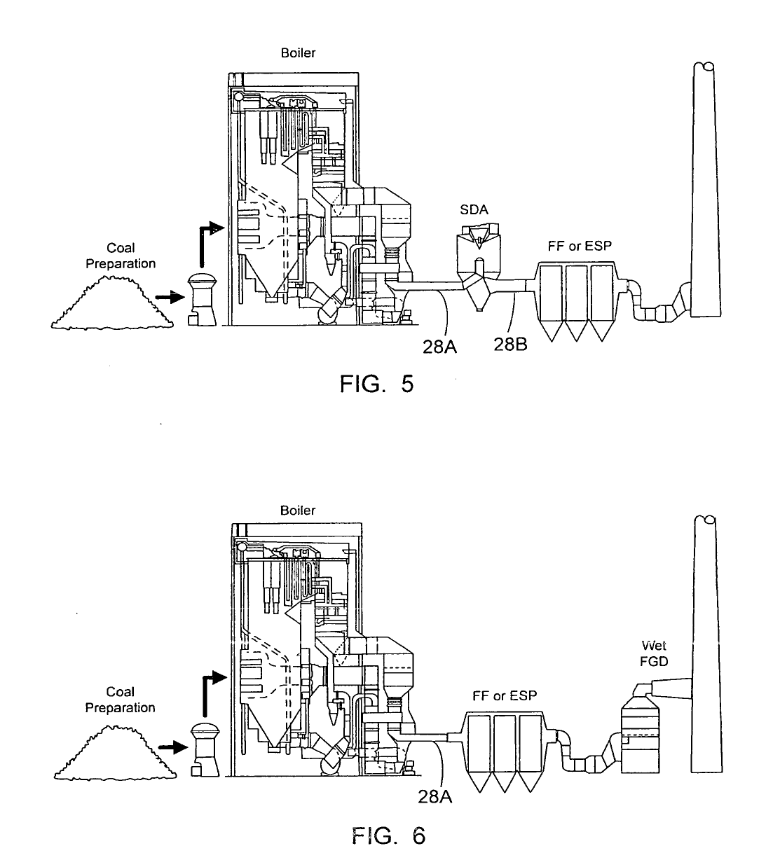

In yet another embodiment, the electric utility plant configurations may include plants equipped with only a particulate collector (FF or ESP) (FIG. 4); an SDA FGD and a particulate collector (FF or ESP) (FIG. 5); or a particulate collector (FF or ESP) and a wet FGD (FIG. 6).

In yet another embodiment, the spent carbonaceous sorbent can be removed separately from the coal fly ash, if desired, by adding an additional particulate collector designed specifically to capture the injected quantity of carbonaceous sorbent.

The present invention takes advantage of the ability to dynamically halogenate the carbonaceous sorbent 14 on site, at the coal-fired utility plant, as needed, thus avoiding any elaborate off-site manufacturing processes. Conventional pneumatic transport equipment can be used, and the mixing of the stream of halogen containing reagent 24 and the stream of carbonaceous sorbent 14 can take place at typical ambient conditions for such equipment at a power plant site; e.g. from about 0 C. to about 50 C. In so far as the specific injection locations 28 where the combined stream of halogen reagent and carbonaceous sorbent may be injected into the mercury-containing flue gas, various locations will suffice. One such location could be into the flue gas stream just downstream (with respect to a direction of flue gas flow through the installation) of the air heaters conventionally used on such power plants, i.e., at location 28A as illustrated in FIGS. 4, 5 and 6, where the flue gas temperature is typically about 150 C., but the flue gas temperature at such location 28A could be up to about 175 C. or as low as about 120 C. Another such location could be into the flue gas stream at a location 28B as illustrated in FIG. 5, which is just upstream of the particulate collector devices (FF or ESP), but downstream of the SDA apparatus.

While specific embodiments of the invention have been shown and described in detail to illustrate the application of the principles of the invention, those skilled in the art will appreciate that changes may be made in the form of the invention covered by the following claims without departing from such principles. For example, the present invention may be applied to new fossil-fueled boiler construction which requires removal of mercury from flue gases produced thereby, or to the replacement, repair or modification of existing fossil-fueled boiler installations. The present invention may also be applied, as described earlier, to new incinerators for the combustion of MSW, or to the replacement, repair or modification of existing incinerators. In some embodiments of the invention, certain features of the invention may sometimes be used to advantage without a corresponding use of the other features. Accordingly, there are other alternative embodiments which would be apparent to those skilled in the art and based on the teachings of the present invention, and which are intended to be included within the scope and equivalents of the following claims of this invention.

We claim:

1. A method of removing a portion of the elemental mercury in a flue gas created during a combustion process, comprising:
providing four streams, wherein the first stream comprises a halogen containing reagent, the second stream comprises a sorbent, the third stream comprises conveyance air, and the fourth stream comprises a flue gas containing elemental mercury;
combining the first, second, and third streams wherein the halogen containing reagent is adsorbed onto the sorbent;
injecting the combined stream into the fourth stream;
adsorbing the elemental mercury onto the sorbent; and
removing the sorbent from the fourth stream.

2. The method according to claim 1, wherein the flue gas is created during the combustion of at least one of a fossil fuel and municipal solid waste.

3. The method according to claim 2, wherein the fossil fuel comprises coal.

4. The method according to claim 1, wherein the halogen containing agent comprises at least one of chlorine, bromine, iodine or fluorine and halide derivatives thereof.

5. The method according to claim 1, wherein the sorbent comprises a carbonaceous sorbent.

6. The method according to claim 5, wherein the carbonaceous sorbent comprises at least one of powdered activated carbon, carbons and chars produced from coal and other organic materials, and unburned carbon produced by a combustion process.

7. The method according to claim 1, wherein the first and second streams are combined at a temperature between about 0 C. and about 50 C.

8. The method according to claim 1, wherein the first, second and third streams are first combined just prior to injection of the combined stream into the fourth stream.

9. The method according to claim 1, wherein the combined stream is injected into the fourth stream at a location where the temperature of the fourth stream is below about 175 C.

10. The method according to claim 1, further comprising the step of adsorbing a substantial portion of oxidized mercury present in the flue gas in addition to the elemental mercury in the fourth stream.

11. The method according to claim 1, further comprising the step of using a fabric filter to remove the sorbent from the fourth stream.

12. The method according to claim 1, further comprising the step of using an electrostatic precipitator to remove the sorbent from the fourth stream.

13. The method according to claim 1, wherein the fourth stream is provided with up to about 4 moles of halogen per million moles of flue gas, and at least about 0.1 pounds of sorbent per million cubic feet of flue gas.
